(19) United States
(12) Patent Application Publication
(10) Pub. No.: US 2007/0232120 A1
(43) Pub. Date: Oct. 4, 2007

(54) Design support system, design support method, and program

(75) Inventor: Akihisa Shimizu, Akishima-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/730,066

(22) Filed: Mar. 29, 2007

(30) Foreign Application Priority Data
Mar. 30, 2006 (JP) 2006-095176

(51) Int. Cl. H01R 13/627

(52) U.S. Cl. 439/358

(57) ABSTRACT

According to one embodiment, a design support system includes an data receiver which receives a CAD data of a component, a physical characteristic receiver which receives a physical characteristic of a harness, a initial settings receiver which receives initial settings of a view point and a sight direction, a displaying section which displays a virtual three-dimensional image seen from the view point on a display device in accordance with the CAD data and the initial settings, a move instruction receiver which receives a move instruction of the view point and the sight direction, a writing section which wires the harness in accordance with the move instruction, and a displaying section which displays a virtual three-dimensional image seen from a changed view point on the display device in accordance with the CAD data and a view point and a sight direction changed according to the move instruction.

### CROSS-REFERENCE TO RELATED APPLICATIONS

This application is based upon and claims the benefit of priority from Japanese Patent Application No. 2006-095176, filed Mar. 30, 2006, the entire contents of which are incorporated herein by reference.

### BACKGROUND OF THE INVENTION

1. Field

One embodiment of the invention relates to design support system and method for supporting a design of wiring a harness.

2. Description of the Related Art

If several electronic components exist in the structural body, a (wiring) harness is used to make an electric connection between electronic components.

Jpn. Pat. Appln. KOKAI Publication No. 2001-93361 discloses the following technique of making a cable wiring design. According to the technique, a structural body is displayed at a high angle in a virtual three-dimensional space to make a cable wiring design.

However, the foregoing technique disclosed in the Publication has the following problem. Namely, it is difficult to make a harness wiring design with respect to a space between complicatedly arrayed components, that is, potion which is not seen on the surface.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram schematically showing t configuration of a design support system according to one embodiment of the present invention;

FIG. 2 is a flowchart to explain a design support method according to one embodiment of the present invention;

FIG. 3 is a view showing a state that the wiring start point is selected with respect to a component displayed on an output device;

FIG. 4 is a view showing a state that a reference plane is selected inclusive of the wiring start point with respect to the component displayed on the output device;

FIG. 5 is a view sowing a state that one normal direction is selected from two normal directions on the reference plane displayed on the output device;

FIG. 6 is a view showing a virtual three-dimensional image seen from a view point displayed on the output device;

FIG. 7 is a view showing a window displayed on the output device when user can not make a wiring design; and

FIG. 8 is a view showing a virtual three-dimensional image including component and harness displayed on the output device aft wiring is completed.

### DETAILED DESCRIPTION

Various embodiments according to the invention will be described hereinafter with reference to the accompanying drawings. In general, according to one embodiment of the invention, A design support system comprises an data receiving section which receives a CAD data of a component, a physical characteristic receiving section which receives a physical characteristic of a harness, a initial settings receiving section which receives initial settings of a view point and a sight direction, a displaying section which displays a virtual three-dimensional image seen from the view point on a display device in accordance with the CAD data of the component and the initial settings, a move instruction receiving which receives a move instruction of the view point and the sight direction, a writing section which wires the harness in accordance with the move instruction, and a displaying section which displays a virtual three-dimensional image seen from a changed view point on the display device in accordance with the CAD data of the component and a view point and a sight direction changed according to the move instruction.

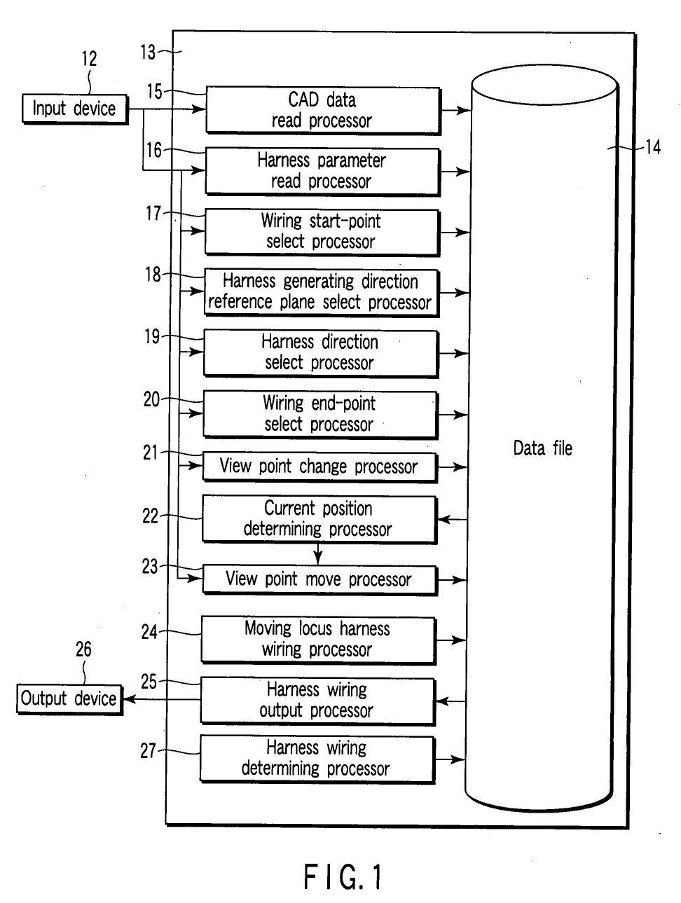

The embodiment of the present invention will be explained below. FIG. 1 shows the configuration of a harness design support system using flythrough. The system is composed of system body 13 as a design support system, input device 14 and output device 26.

The system body 13 includes, data file 14, CAD data read processor 15, harness parameter read processor 16 and wiring start point select processor 17 and. The system body 13 further includes harness generating direction reference plane select processor 18, harness direction select processor 19, wiring end point select processor 20 and view point change processor 21. The system body 13 further includes current position determining processor 22, view point move processor 23, moving locus harness wiring processor 24, and harness wiring output processor 25.

The CAD data read processor 15 receives CAD data of a component from the input device 12, and stores it in the data file 14. Then, the processor 15 generates image data for a three-dimensional model of the component on a virtual three-dimensional space (output device 26) from the received CAD data.

The harness parameter read processor 16 receives harness parameters such as thickness (cross-sectional shape), maximum bend curvature and color of the harness inputted by user. Then, the processor 16 stores start point information in the data file 14.

The wiring start point select processor 17 receives the wiring start point inputted by user from the input device 12, and stores the start point information in the data file 14. The harness generating direction reference plane select processor 18 receives a plane including the wiring start point inputted by user, and sores plane information in the data file 14. The harness direction select processor 19 supports user in selecting one normal direction from two normal directions o the plane. Thereafter, the processor 19 stores the selected normal direction information in the data file 14.

The wiring end point select processor 20 receives the wiring end point inputted by user, and stores wiring end point information in the data file 14.

The view point change processor 21 generates a virtual three-dimensional image data seen from the wiring start point (view point) based on CAD data of the component, wiring start point, reference plane and normal direction.

The current position determining processor 22 determines whether or not the view point position is the wiring end point.

The view point move processor 23 receives a move instruction of the view point and the sight line direction inputted by user via the input device 12. Then, the processor 23 gives the move instruction to the moving locus harness wiring processor 24 and the harness wiring output processor 25.

The moving locus harness wiring processor 24 executes harness wiring processing based on a locus on which the view point moves according to the move instruction. Moreover, the moving locus harness wiring processor 24 outputs harness wiring data (CAD data).

The harness wiring output processor 25 generates a virtual three-dimensional image data seen from the view point in response to the move instruction.

A harness wiring determining processor 27 refers to harness parameters and the shape of the component after a harness design is completed. Thereafter, the processor 27 determines whether or not the harness is actually wired.

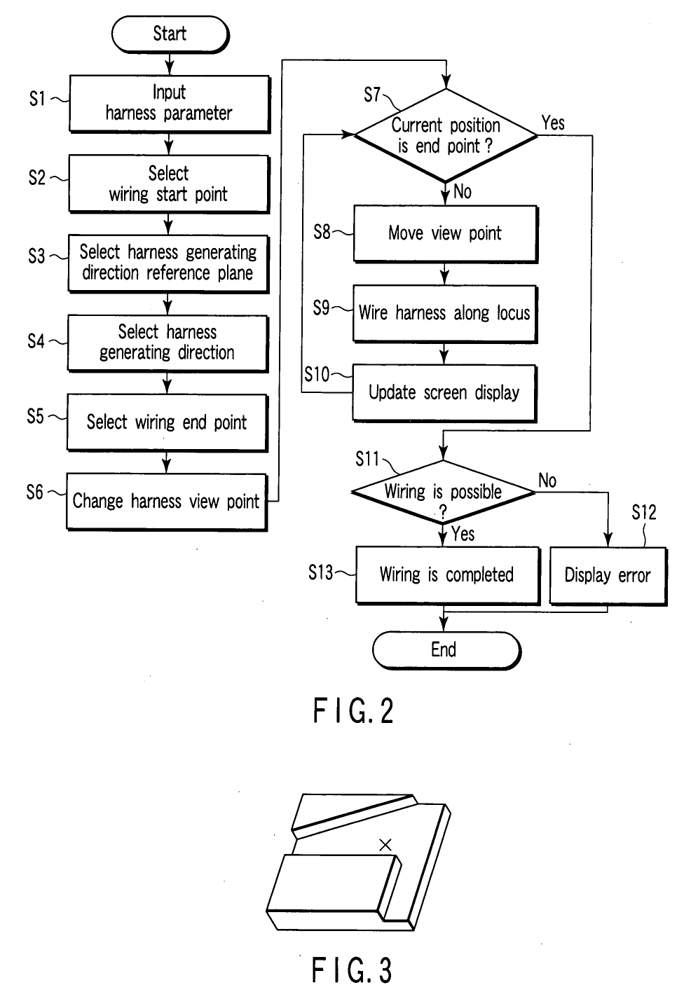

The operation of the system having the foregoing configuration will be hereinafter explained with reference to a flowchart shown in FIG. 2.

First, user inputs three-dimensional CAD data made by a designer to the system body 13 using the input device 12. The system body 13 stores the inputted CAD data in the data file 14 via the CAD data read processor 15.

The CAD data read processor 15 displays a three-dimensional model of the component according to the CAD data stored in the data file 14 on the output device 26.

User inputs parameters such as thickness (cross-sectional shape), maximum bend curvature and color of the harness to the harness parameter read processor 16 using the input device 12 before starting harness wiring (block S1). In this case, user previously stores a library including several kinds of harness parameters in the data file 14, and the, may select a harness parameter from the library.

As shown in FIG. 3, the wiring start point select processor 17 supports user in selecting a point, which is used as the start point of harness wiring with respect to the CAD data stored in the data file 14. Thereafter, the processor 17 writes the selected result in the data file 14 (block S2). In order to capture the point used as the start point, the wiring start point select processor 17 displays a pointer moving in response to an operation of the input device 12 such as a mouse. Then, user selects the point used as the start point. Moreover, the processor 17 displays an input window for inputting a coordinate so that user input the coordinate.

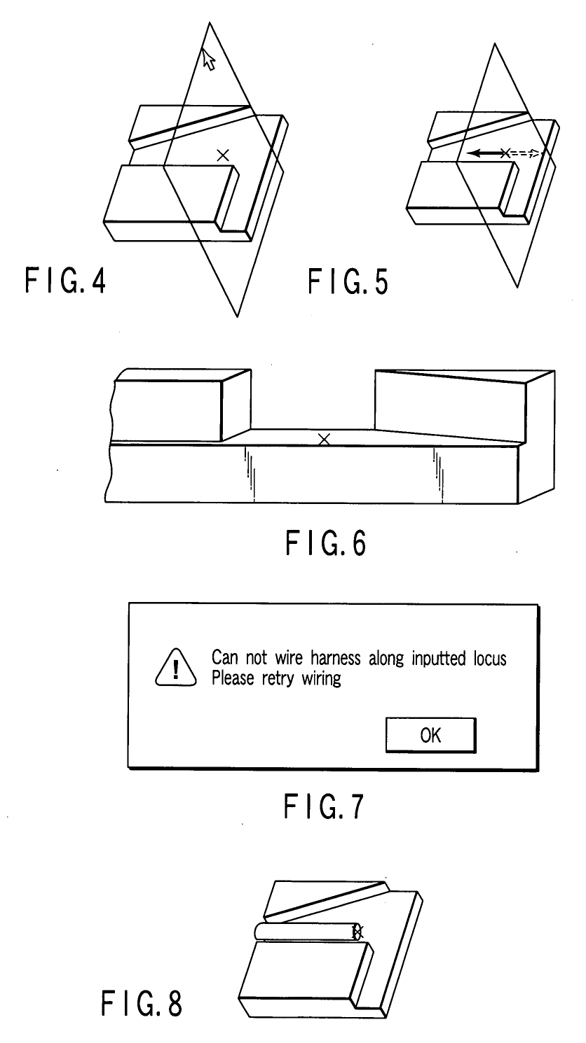

As illustrated in FIG. 4, the harness generating direction reference plane select processor 18 supports user in selecting a plane used as a reference for determining a harness wiring direction, and then, writes the selected result in the data file (block S3). In this case, the point selected in block S2 exists on the plane selected by user.

In order to select the reference plane by user, the harness generating direction reference plane select processor 18 displays the pane together with the component. In this case, the plane includes the start point, and rotates in response to an operation of the input device 12 such as a mouse. In this manner, the processor 18 supports user in selecting the plane, and then, writes the selected plane information in the data file 14.

Two normal directions exit on the plane selected in block S2. The harness direction select processor 19 displays two normal directions. Then, the processor 19 support user in selecting one of the foregoing two normal directions (sight line direction), and writes the selected result in the data file 14 (block S4). FIG. 5 shows a state that the normal direction is selected. In FIG. 5, the black arrow denotes the selected normal direction. The procedures from block S2 to block S4 are taken, the initial position of the sight line and the sight line direction is set.

The wiring end point select processor 20 supports user in selecting the wiring end point, and then, writes the selected result in the data file 14 (block S5). The procedure of selecting the wiring end point is the same as the procedure of selecting the start point in block S1.

The view point change processor 21 refers to the start point, the reference plane and the generating direction, which are written in the data file 14. Thereafter, the processor 21 generates a virtual three-dimensional image, that is, image data when the harness generating direction is viewed from the wiring start point. The, the processor 21 displays the image data sown in FIG. 6 on the output device 26 (block S6).

The current position determining processor 22 determines whether or not the current view point position is the end point selected in block S5 (block S7). If the current view point position is no the end point (No in block S7), the current position determining processor 22 gives information that the current position is not the end point to the view point move processor 23. Then, the view point move processor 23 moves the view point in response to the operation of the input device 12 by user to generate image data, and thereafter, displays it on the output device 26 (block S8).

The move locus harness wiring processor 24 wires a harness in accordance with the locus where the viewpoint moves (block S9). When the view point moves, the harness wiring output processor 25 update the displayed image, and thereafter, user can see the updated image via the output device 26 (block S10).

In block S7, if it is determined that the current view point position is the end point (Yes in block S7), the current position determining processor 22 takes the following procedure. Specifically, the processor 22 gives information that the current view point position is the end point to the view point move processor 23 and the harness wiring determining processor 27.

The harness wiring determining processor 27 refers to the shape of the component based on CAD data and physical characteristic such as the maximum bend curvature included in harness parameters. Then, the processor 27 determines whether or not the harness is actually wired along the path from the wiring start point to the end point (block S11). If the path such that the harness is not actually wired is given (No in block S11), the processor 27 displays a window shown in FIG. 7, for example. Namely, the processor 27 displays the window describing information that the harness is not actually wired on the output device 26 (block S12). If the path such that the harness is actually wired is given (Yes in block S11), wiring is completed (block S13). Wiring is completed, and thereafter, the processor 27 displays component and wired harness on the output device 26 as seen from FIG. 8

With the foregoing configuration, the following advantages are given. Specifically, it is possible to readily wire a harness between components, which are complicatedly arrayed and usually hard to be wired at the view point such as high angle. Moreover, it is possible to reduce time spent for making a design of wiring a harness.

Incidentally, it is determined whether or not wiring is actually possible after wiring is completed. In this case, it may be determined whether or not wiring is actually possible every when the procedure of block S9 is taken, that is, the harness is wired in accordance with the locus to which the view point moves. If it is determined that the harness is not actually wired, information that the harness is not actually wired is displayed. Moreover, the view point is automatically returned to the position capable of wiring the harness, or user may select the position of returning the view point.

During wiring, components and the state of the harness wired thus far are displayed on a window at high angle. By doing so, user is easy to grasp the current view point position.

The procedures for supporting the harness wiring design using the harness design support system of this embodiment are all realized by a computer program. Thus, the computer program is installed on a normal computer via a computer readable storage medium. By doing so, the same effect as this embodiment is readily realized. Moreover, the computer program is executable on various electronic apparatuses having a built-in processor in addition to a personal computer.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A design support system comprising:
an data receiving section which receives a CAD data of a component;
a physical characteristic receiving section which receives a physical characteristic of a harness;
a initial settings receiving section which receives initial settings of a view point and a sight direction;
a displaying section which displays a virtual three-dimensional image seen from the view point on a display device in accordance with the CAD data of the component and the initial settings;
a move instruction receiving section which receives a move instruction of the view point and the sight direction;
a writing section which wires the harness in accordance with the move instruction; and
a displaying section which displays a virtual three-dimensional image seen from a changed view point on the display device in accordance with the CAD data of the component and a view point and a sight direction changed according to the move instruction.

2. The system according to claim 1, wherein the initial settings receiving section includes:
a start point receiving section which receives a start point;
a plane receiving section which receives a plane including the start point; and
a normal direction receiving section which receives selected one normal direction from two normal directions on the plane.

3. The system according to claim 1, further comprising:
a receiving section which receives a wiring end point; and
a referring section which refers to the physical characteristic of the harness to determine whether or not wiring is actually possible if the view point reaches the wiring end point.

4. A design support method comprising:
preparing a CAD data of a component;
preparing a physical characteristic of a harness;
preparing initial settings of a view point and a sight direction;
displaying a virtual three-dimensional image seen from the view point in accordance with the CAD data of the component and the initial settings;
wiring the harness in accordance with the move instruction of the view point and the sight direction; and
displaying a virtual three-dimensional image seen from a changed view point on the display device in accordance with the CAD data of the component and a view point and a sight direction changed according to the move instruction.

5. The method according to claim 4, wherein the preparing initial settings includes:
preparing a start point;
preparing a plane including the start point; and
selecting one normal direction from two normal directions on the plane.

6. The method according to claim 4, further comprising:
preparing a wiring end point; and
referring to the physical characteristic of the harness to determine whether or not wiring is actually possible if the view point reaches the wiring end point.

7. A program which is stored in a computer readable media and cause a computer to perform harness wiring design process, comprising:
causing the computer to execute a processing of reading a CAD data of a component;
causing the computer to execute a processing of reading a physical characteristic of a harness;
causing the computer to execute a processing of reading initial settings of a view point and a sight direction;
causing the computer to execute a processing of generating an image data seen from the view point in accordance with the CAD data of the component and the initial settings;
causing the computer to execute a processing of wiring the harness in accordance with a move instruction of the view point and the sight direction; and
causing the computer to execute a processing of displaying a virtual three-dimensional image seen from a changed view point on the display device in accordance with the CAD data of the component and a view point and a sight direction changed according to the move instruction.

8. The program according to claim 7, wherein the initial settings includes a start point, a plane including the start point and one of two normal directions on the plane.

9. The program according to claim 7, further comprising:
causing the computer to execute a processing of reading a wiring end point; and
causing the computer to execute a processing of referring to the physical characteristic of the harness to determine whether or not wiring is actually possible if the view point reaches the wiring end point.
